(19) United States
(12) Patent Application Publication
(10) Pub. No.: US 2026/0192828 A1
(43) Pub. Date: Jul. 9, 2026

(54) Method and Device for Operating a Hands-off Function of a Vehicle

(71) Applicant: Bayerische Motoren Werke Aktiengesellschaft, Muenchen (DE)

(72) Inventors: Felix REMPE, Dachau (DE); Jakob Reuter, Muenchen (DE)

(21) Appl. No.: 19/440,804

(22) Filed: Jan. 6, 2026

(30) Foreign Application Priority Data
Jan. 7, 2025 (DE) 10 2025 100 217.7

(51) Int. Cl. B60W 60/00; B60W 30/18

(52) U.S. Cl. CPC B60W 60/0051; B60W 30/18163; B60W 2540/229

(57) ABSTRACT

A device is described for operating a hands-off (HO) function of a vehicle, wherein the device is configured to operate a state machine for the HO function. The state machine has a plurality of different activated HO states for the activated HO function and a deactivated HO state, in which the HO function is deactivated. The device is configured to select the HO state of the state machine based on a driving situation of the vehicle, and to operate the HO function in the driving situation according to the selected HO state.

### CROSS REFERENCE TO RELATED APPLICATION

This application claims priority under 35 U.S.C. § 119 from German Patent Application No. DE 10 2025 100 217.7, filed Jan. 7, 2025, the entire disclosure of which is herein expressly incorporated by reference.

### BACKGROUND AND SUMMARY

The invention relates to a method and a corresponding device which are directed to operating a hands-off function of a (motor) vehicle.

A vehicle can have one or more driver assistance systems, which are each designed to longitudinally and/or laterally guide the vehicle in an automated manner. During the operation of a driver assistance system, it can be made possible for the driver of the vehicle to permanently take his hands off the steering means, in particular off of the steering wheel, of the vehicle. This option can be referred to as the hands-off (HO) option or as the hands-off (HO) function. The provision of the HO function can be activated (offered) or deactivated (not offered) depending on the complexity of the respective existing driving situation.

The present document relates to the technical object of effectuating particularly convenient and safe operation of the HO function (i.e., the HO option) of a vehicle.

The object is achieved by each of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device for operating a hands-off (HO) function of a (motor) vehicle is described. The HO function can be activated while the vehicle is laterally and possibly longitudinally guided in an automated manner. The driver of the vehicle can be enabled in the context of the activated HO function to permanently take his hands off the steering means, in particular the steering wheel, of the vehicle. The HO function can be activated and/or remain activated as long as automated lateral guidance of the vehicle can be effectuated with a relatively high level of reliability and/or confidence. On the other hand, if the level of reliability and/or confidence for the automated lateral guidance of the vehicle decreases, and there is a relatively high risk that the automated lateral guidance will have to be terminated and/or that a transfer of the lateral guidance to the driver of the vehicle has to be carried out, the HO function can be deactivated to cause the driver to grasp the steering means with his hands. The automated lateral guidance of the vehicle can then be continued with deactivated HO function. It can be monitored by the device during the automated lateral guidance with deactivated HO function that the driver keeps his hands on the steering means (and only takes them off the steering means temporarily (for example, for a defined maximum period of time, such as 10 seconds or less)). In other words, hands-on monitoring can be carried out when the HO function is deactivated.

The device is configured to operate a state machine for the HO function. The state machine can have multiple different activated HO states for the activated HO function. Furthermore, the state machine can have a deactivated HO state in which the HO function is deactivated.

The multiple different activated HO states can comprise N activated HO states, with N≥2, each of which is associated with a different probability that the HO function will remain activated starting from the current time over a defined minimum period of time. The minimum period of time can correspond to the (deactivation) period of time required for the deactivation of the HO function. The deactivation can be started, for example, with the output of a request to the driver to place his hands on the steering means. The actual deactivation of the HO function (with the subsequent hands-on monitoring) can be effectuated after expiration of the deactivation period of time.

Alternatively or additionally, the multiple different activated HO states can comprise a lane change HO state, which is directed to a lane change of the vehicle onto another lane, on which the probability that the HO function will remain activated starting from the current time over the defined minimum period of time, is greater than on the lane on which the vehicle is traveling at the current time.

Particularly convenient and safe operation of the HO function can be effectuated by providing multiple different activated HO states (for the activated HO function).

The device is furthermore configured to select the HO state of the state machine for a driving situation (for example, for the respective current or for an immediately upcoming driving situation) of the vehicle. The device can be configured to determine sensor data with respect to the surroundings of the vehicle in the driving situation by means of one or more surroundings sensors of the vehicle. The HO state of the state machine for the driving situation of the vehicle can be selected in a precise and robust manner based on the sensor data of the one or more surroundings sensors.

The device is furthermore configured to operate the HO function in the driving situation according to the selected HO state. As already described, the different activated HO states can be associated with different probabilities that the HO function will remain activated starting from the current time over the defined minimum period of time.

The device can be configured, with decreasing probability of the respective selected (activated) HO state to increase the amount and/or the degree of detail of information which is output (displayed) via the user interface of the vehicle (and/or to reduce it with increasing probability). The output information can relate to the surroundings of the vehicle and/or to the driving strategy (for example, to the upcoming trajectory) of the vehicle in the driving situation.

Alternatively or additionally, the device can be configured, with decreasing probability of the respective selected (activated) HO state, to increase the extent of the monitoring of the attentiveness of the driver (and/or to reduce it with increasing probability). The attentiveness which the driver of the vehicle has for the (respective current) driving situation can be monitored here in particular.

As described above, the state machine N can have different activated HO states which are associated with N different probabilities. The amount and/or the degree of detail of the output information and/or the extent of the monitoring of the driver attentiveness can each be increased or reduced in N steps for the corresponding N different activated HO states.

The convenience and safety of the HO function can be increased reliably by the adaptation of the operation of the HO function to the respective activated HO state.

The device can be configured to identify a section of the roadway network (traveled by the vehicle), in which the (current or immediately upcoming) driving situation is playing out. Furthermore, the device can be configured to determine a standard HO state of the HO function in the identified section based on the digital map for the roadway network. The digital map can be designed such that the digital map specifies the standard HO state of the HO function in each case for a plurality of different sections. The digital map (the standard HO states for the different sections) can have been trained beforehand on the basis of training data (and on the basis of a method for machine learning). The training data can specify for each of a plurality of actual journeys whether the HO function was actually activated or deactivated in a section of the roadway network.

The HO state of the state machine for the (current or directly upcoming) driving situation of the vehicle can then (also) be selected in a particularly precise and robust manner on the basis of the standard HO state. For example, the standard HO state can be adapted depending on the sensor data of the one or more surroundings sensors for the surroundings in the (current or immediately upcoming) driving situation to select the HO state for the driving situation.

The device can be configured, based on sensor data of the one or more surroundings sensors and/or the digital map for the roadway network traveled by the vehicle, to determine probability information with respect to the probability that the HO function will remain activated in the driving situation starting from the current time over the defined minimum period of time. The HO state of the state machine for the driving situation of the vehicle can then be selected in a particularly precise manner based on the probability information.

Alternatively or additionally, the device can be configured to determine, based on sensor data of the one or more surroundings sensors and/or the digital map for the roadway network traveled by the vehicle, that the probability that the HO function will remain activated starting from the current time over the defined minimum period of time, is greater on another lane than on the lane on which the vehicle is traveling at the current time. If this is recognized, the HO function can be transferred into the lane change HO state of the state machine, wherein the lane change HO state is directed to a lane change of the vehicle onto the other lane.

The device can furthermore be configured (while the HO function is in the lane change HO state) to output a notification with respect to the lane change to be carried out to the driver of the vehicle via the user interface. Alternatively or additionally, the lane change to the other lane can be carried out in an automated manner. Particularly robust and reliable operation of the HO function can thus be effectuated.

As already described, the device can be configured, while the state machine is in an activated HO state, to effectuate automated lateral guidance of the vehicle. Furthermore, the driver of the vehicle can be enabled during the automated lateral guidance of the vehicle to permanently take his hands off the steering means, in particular off of the steering wheel, of the vehicle (without hands-on monitoring being carried out and/or without a request being output to the driver to place his hands on the steering means after expiration of a predefined maximum period of time). The non-holding of the steering means can be enabled as long as the HO function is in an activated HO state (and as long as deactivation of the HO function has not been initiated).

The device can furthermore be configured, if the state machine changes to the deactivated HO state and/or if (possibly as long as) the state machine is in the deactivated HO state, to effectuate (continue) automated lateral guidance of the vehicle. Furthermore, hands-on monitoring can be carried out to ensure that the driver of the vehicle keeps his hands on the steering means (and only takes them off the steering means temporarily for at most a maximum period of time).

According to a further aspect, a (road) motor vehicle (a passenger vehicle or a truck or a bus or a motorcycle) is described, which comprises the device described in this document.

According to a further aspect, a method for operating a hands-off (HO) function of a (motor) vehicle is described. The method comprises operating a state machine for the HO function, wherein the state machine has multiple different activated HO states for the activated HO function and has a deactivated HO state in which the HO function is deactivated. The method furthermore comprises selecting the HO state of the state machine for a (current or upcoming) driving situation of the vehicle. Furthermore, the method comprises operating the HO function in the driving situation according to the selected HO state. A different operation of the HO function can thus be effectuated in each case for different HO states.

It is to be noted that the aspects described in conjunction with the device, in particular the claims described in conjunction with the device, are also to be applied as corresponding method features to the method.

According to a further aspect, a software (SW) program is described. The SW program can be configured to be executed on a processor (for example, on a control unit of a vehicle), and to thus carry out the method described in this document.

According to a further aspect, a non-transitory computer-readable storage medium is described. The storage medium can comprise an SW program which is configured to be executed on a processor and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention is described in more detail hereinafter based on exemplary embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary components of a vehicle;

FIG. 2 shows an exemplary state machine having different HO states; and

FIG. 3 shows a flow chart of an exemplary method for operating an HO function of a vehicle.

### DETAILED DESCRIPTION OF THE DRAWINGS

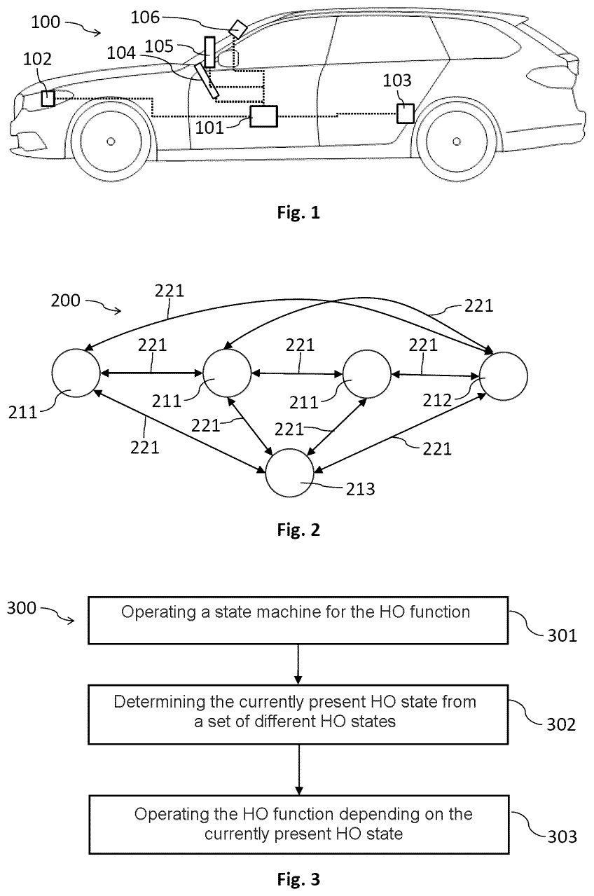

As described at the outset, the present document relates to increasing the level of convenience and/or safety of the HO function of a vehicle. The HO function can enable the driver of the vehicle to permanently take his hands off the steering means, in particular off the steering wheel, of the vehicle. In this context, FIG. 1 shows an exemplary vehicle 100 having one or more surroundings sensors 102, which are each configured to capture sensor data (which are also referred to as surroundings data) with respect to the surroundings of the vehicle 100. Exemplary surroundings sensors 102 are a camera, a radar sensor, a lidar sensor, an ultrasonic sensor, etc.

A (control) device 101 of the vehicle 100 can be configured to evaluate the surroundings data, for example, to recognize one or more objects (such as other vehicles and/or lane markings) in the surroundings of the vehicle 100. The device 101 can furthermore be configured to effectuate automated longitudinal and/or lateral guidance of the vehicle 100 based on the surroundings data, in particular based on the one or more detected objects. For this purpose, one or more longitudinal and/or lateral guidance actuators 103 (e.g., a drive motor, a braking device, and/or a steering device) of the vehicle can be actuated.

The automatic longitudinal guidance of the vehicle 100 can be effectuated, for example, by a speed and/or distance regulator. The actual distance of the vehicle 100 to a front vehicle traveling directly in front of the vehicle 100 can be determined here based on the surroundings data. Furthermore, the actual distance can be adjusted, in particular regulated, by the distance regulator to a predefined target distance. The target distance can have been defined by the user, for example via a user interface 105 of the vehicle 100.

The automatic lateral guidance of the vehicle 100 can be effectuated, for example, by a lane keeping assistant which is configured to drive the vehicle 100 in an automated manner within the current lane (i.e. within the current traffic lane), without the driver of the vehicle 100 having to operate the steering means 104, in particular the steering wheel, of the vehicle 100 for this purpose.

The driver of the vehicle 100 can be enabled in the context of the operation of a driver assistance system having automated lateral guidance and possibly automated longitudinal guidance to take his hands permanently (and not only temporarily for a period of time of 10 seconds or less) off the steering means 104. This option for the driver can be referred to as a hands-off (HO) option or as an HO function. The device 101 can be configured to determine on the basis of the surroundings data and possibly on the basis of further information, for example on the basis of a digital map for the roadway network traveled by the vehicle 100, whether the HO function is activated at a specific time (so that the driver can permanently take his hands off of the steering means 104) or is deactivated (so that the driver has to keep his hands on the steering means 104, and can only take them off of the steering means 104 temporarily (for example, for a period of time of less than 10 seconds)).

The binary activation or deactivation of the HO function can be perceived as inconvenient and/or unsafe by the driver of the vehicle 100. A notification can possibly be output to the driver via the user interface 105 in the preparation for the deactivation of the HO function, that the HO function will shortly be deactivated, to give the driver enough time to place his hands on the steering means 104. The deactivation of the HO function can extend, for example, over a deactivation period of time, wherein the deactivation period of time can begin with the output of the notification and can end with the actual deactivation of the HO function (and the hands-on monitoring connected thereto).

FIG. 2 shows an exemplary state machine 200 for the operation of the HO function. The state machine 200 has multiple different states 211, 212 for the activated HO function, which are each also referred to as activated HO states 211, 212 in this document. Furthermore, the state machine 200 has a state 213 for the deactivated HO function, which is also referred to in this document as the deactivated HO state 213. Furthermore, the state machine 200 has transition conditions 221 for the transitions between the different HO states 211, 212, 213. The individual transition conditions 221 can each be associated with one or more probability threshold values, as described below.

The different activated HO states 211, 212 can differ with respect to the reliability and/or probability that the HO function can remain activated over a defined minimum period of time. The minimum period of time can correspond, for example, to the above-mentioned deactivation period of time (which is required for the deactivation of the HO function). The device 101 can be configured to determine, based on the surroundings data and possibly based on the digital map, probability information with respect to the reliability and/or the probability that the HO function can remain activated over the defined minimum period of time. Furthermore, the device 101 can be configured to determine the activated HO state 211, 212 of the state machine 200 for the HO function depending on the probability information. For this purpose, the probability information can be compared, for example, to one or more probability threshold values.

The state machine 200 can comprise, for example, as activated HO states 211:
a first activated HO state 211, which is present if the probability is equal to or greater than a first probability threshold value; the first probability threshold value can be, for example, at 95% or higher;
a second activated HO state 211, which is present if the probability is less than the first probability threshold value and possibly equal to or greater than a second probability threshold value; the second probability threshold value is less than the first probability threshold value, for example 70%; and/or
a third activated HO state 211, which is present if the probability is less than the
second probability threshold value possibly equal to or greater than a third probability threshold value; the third probability threshold value is less than the second probability threshold value, for example 40%.

Therefore, N different activated HO states 211 can be defined for N different probability intervals, with N≥2.

Furthermore, the state machine 200 can have at least one activated HO state 212, which is associated with a lane change of the vehicle 100 to a different lane of the currently traveled roadway. The device 101 can be configured to determine, based on the surroundings data and possibly based on the digital map, probability information with respect to the probability of the continuing operation of the HO function on one or more adjacent lanes. If it is recognized that the probability of the continuing operation of the HO function on an adjacent lane is higher than the probability of the continuing operation of the HO function on the current lane, a transition can be effectuated from the respective current activated HO state 211 to the lane change HO state 212.

The HO function can be operated depending on the respective current activated HO state 211, 212. Information output via the user interface 105 of the vehicle 100 for the driver can depend on the respective current activated HO state 211, 212. Alternatively or additionally, the monitoring of the driver based on driver data, which are captured by means of one or more driver sensors 106 (for example, by means of a camera directed at the driver), can depend on the respective activated HO state 211, 212.

The transition conditions 221 between the different activated HO states 211, 212 can be trained based on training data (for example, by machine learning). The training data can be generated based on actual journeys of vehicles within the roadway network traveled by the vehicle 100.

Therefore, a combination of a state machine 200 in a vehicle 100 with additional elements and optionally the linkage of the state machine 200 with driving data for journeys in a roadway network is described. The state machine 200 can have the following modes or HO states 211, 212, 213:
a first activated HO state 211, which is typically associated with a particularly high probability for the continued activated operation of the HO function;
a second activated HO state 211, which is typically associated with a reduced, but still relatively high probability for the continued activated operation of the HO function; the second activated HO state can have the focus of building up trust for the HO function in the driver of the vehicle 100;
a third activated HO state 211, which is typically associated with a further reduced probability for the continued activated operation of the HO function;
the third activated HO state can have the focus of monitoring and/or increasing the attentiveness of the driver in preparation for a possible deactivation of the HO function;
a lane change HO state 212, which is directed to effectuating or proposing a lane change onto another lane to increase the probability of the HO function; and/or
a deactivated HO state 213.

The device 101 can be configured to output, in particular to display, the respective current HO state 211, 212, 213 via the user interface 105 of the vehicle 100.

In the second activated HO state 211, the one or more essential influencing factors on a possible deactivation of the HO function can be displayed via the user interface 105 (on a display screen and/or head-up display). The driving function for automated lateral and possibly longitudinal guidance can continue to be relatively confident of being able to manage the current driving situation, even if there is a relatively small probability that the HO function will have to change to another HO state 211 and possibly be deactivated.

In the third activated HO state 211, the driving function has a reduced confidence in relation to the second activated HO state 211 that the HO function can continue to remain activated. The probability for the continued operation of the HO function is still greater than 0, however. It is possible to cause by one or more measures that the driver can intervene relatively quickly if taking over of the lateral guidance of the vehicle 100 and/or a driver reaction is necessary. For this purpose, for example, one or more potentially hazardous objects, for example a potentially intersecting vehicle, can be output via the user interface 105, in particular displayed on a display screen (possibly as in the second activated HO state 211). Furthermore, it can be checked based on the driver data of the one or more driver sensors 106 (for example, by means of an eye tracker which tracks the gaze of the driver) that the driver has recognized and possibly observes the one or more hazardous objects.

In the lane change HO state 212, a suggestion to carry out a lane change can be output by the device 101, or a lane change can be carried out in an automated manner in order to change from a currently traveled lane having a relatively high risk for a degradation of the automated lateral guidance and/or for the deactivation of the HO function to another lane having a relatively low risk for a degradation of the automated lateral guidance and/or for the deactivation of the HO function.

During the operation of one or more vehicles, data on the dynamic traffic and/or information on the actual use of the hands-off function can be captured with one or more drivers. Information about the traffic behavior of the respective surrounding vehicles, information on the quality of the respective roadway, and/or information on the weather can be captured and aggregated in the backend server. The aggregated information can be used (for example, as training data) to predict a probability for each of a plurality of different sections (for example, route sections) of the roadway network that the HO function can be activated in the respective section. A standard HO state of the state machine 200 in the different sections of the roadway network can be determined based on the training data.

For a vehicle 100 which drives into a specific section (for example, route section), a prediction for the probability of the activation of the HO function in the respective section can therefore be calculated. Further influences, in addition to the static influences calculated in preparation, are the current weather conditions, the current traffic conditions and/or traffic density, and/or the current light conditions. Depending on the probability from the backend server (for example, depending on the standard HO state) and depending on the information from the surroundings sensors 102 of the vehicle 100, an optimized trajectory (a suitable lane) can be determined for the current or upcoming section and the most fitting HO state 211, 212, 213 can be selected.

Therefore, the probability P for the activation of the HO function can be learned from historic driving data. The state machine 200 can compare the learned probability P to static threshold values to change into one of the different states 211, 212, 213 of the state machine 200.

In one example, the vehicle 100 having activated HO function drives toward a roundabout. The state machine 200 can be in the first activated HO state 211. Upon further approach to the roundabout, it is possible to change to the second activated HO state 211, since the probability that the HO function can continue to remain activated decreases. While the HO function is in the second activated HO state 211, the trajectory of the vehicle 100 through the roundabout can be displayed to the driver on the display screen of the user interface 105. The driver thus understands the intention of the vehicle 100 and can calmly take his hands off the steering wheel 104.

The vehicle approaches further to the roundabout, and another vehicle, which drives on the outer lane in the roundabout, is possibly detected based on the surroundings data of the one or more surroundings sensors 102 of the vehicle 100. This vehicle will presumably either (i) continue to drive in the roundabout, and intersect the trajectory of the vehicle 100 in this case, so that the driver 100 has to remain stationary at the entry into the roundabout, or (ii) depart the roundabout and so release the lane for the vehicle 100, so that the vehicle 100 can drive into the roundabout. Since the situation is unclear, and possibly requires the driver to take over, the system changes to the third activated HO state 211. The other vehicle can be marked for the driver on the display screen (on the head-up display). While the vehicle 100 continues to drive toward the roundabout with activated HO function, it can be checked based on the driver data of the one or more driver sensors 106 that the driver has the other vehicle in view. A notification can be output to the driver when it is recognized that the driver has inadequate attentiveness.

It can be recognized based on the surroundings data that the other vehicle changes to the inner ring of the two-lane roundabout. Since the vehicle 100 will leave the roundabout again at the next exit, a lane change can be carried out (and a transition to the lane change HO state 212 can be carried out). After the lane change, a collision with the other vehicle in the roundabout is improbable, so that it is possible to change to the second activated HO state 211 after the lane change.

Finally, the vehicle 100 drives with activated HO function in the roundabout. After departing the roundabout, it is possible to change back into the first activated HO state, since no significant interfering factors for the HO function are expected on the adjacent route segment. This information can have been determined based on historic driving data (and stored in the digital map as the standard HO state).

In the context of the capture of the driving data, the actual activation of the HO function and possibly further information on the respective current driving events can be collected from one or more vehicles. These driving data can be used by spatial (and possibly lane-accurate) aggregation as the basis for calculating the probability for the activation of the HO function (and in particular for the calculation of the standard HO state).

FIG. 3 shows a flow chart of an exemplary (possibly computer-implemented) method 300 for operating a hands-off (HO) function of a (motor) vehicle 100. The method 300 can be carried out by a (control) device 101 of the vehicle 100. The vehicle 100 can be laterally and possibly longitudinally guided in an automated manner. During the automated lateral guidance of the vehicle 100, the driver can be enabled by activation of the HO function to permanently take his hands off the steering means 104, in particular off the steering wheel, of the vehicle 100. On the other hand, it can be necessary for the driver with deactivated HO function to hold the steering means 104 with his hands (even if automated lateral guidance of the vehicle 100 is effectuated).

The method 300 comprises operating 301 a state machine 200 for the HO function, wherein the state machine 200 has multiple different activated HO states 211, 212 for the activated HO function and a deactivated HO state 213, in which the HO function is deactivated. The different activated HO states 211, 212 can be associated with different probabilities that the HO function will remain activated for longer than a defined minimum period of time. The deactivation of the HO function can be required, for example, if the current driving situation is sufficiently complex that a termination of the automated lateral guidance and a transfer of the lateral guidance to the driver is to be expected. The HO function can then be deactivated, so that the driver already holds his hands on the steering means 104 for the case of a (later) termination of the automated lateral guidance.

The method 300 furthermore comprises selecting 302 the HO state 211, 212, 213 of the state machine 200 for a (in particular for the current or for an immediately upcoming) driving situation of the vehicle 100. The HO state 211, 212, 213 can be selected based on the surroundings data of the one or more surroundings sensors 102 of the vehicle 100 and/or based on the digital map for the roadway network traveled by the vehicle 100.

Furthermore, the method 300 comprises operating 303 the HO function in the driving situation according to the selected HO state 211, 212, 213. In this case, the amount of information output to the driver during the automated lateral guidance, and/or the extent of the monitoring of the attentiveness of the driver can depend on the selected (activated) HO state 211, 212, 213.

Particularly convenient and safe operation of the HO function can be effectuated by the use of a state machine 200 having multiple different activated HO states 211, 212 for the operation of the HO function.

The present invention is not restricted to the exemplary embodiments shown. It is to be noted that the description and the figures are only to illustrate the principle of the proposed methods, devices, and systems by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for operating a hands-off (HO) function of a vehicle, wherein the device is configured to:
operate a state machine for the HO function, wherein the state machine has a plurality of different activated HO states for the HO function and a deactivated HO state, in which the HO function is deactivated;
select one of the different activated HO states of the state machine as a selected HO state based on a driving situation of the vehicle; and
operate the HO function in the driving situation according to the selected HO state.

2. The device according to claim 1, wherein the device is further configured to:
identify a section of a roadway network in which the driving situation plays out;
based on a digital map for the roadway network, determine a standard HO state of the HO function in the section, wherein the digital map specifies the standard HO state of the HO function for each of a plurality of different sections; and
select the HO state of the state machine for the driving situation of the vehicle based on the standard HO state.

3. The device according to claim 2, wherein the digital map is configured based on training data, which specify for each of a plurality of journeys whether the HO function was actually activated or deactivated in a section of the roadway network.

4. The device according to claim 1, wherein the device is further configured to:
determine sensory data with respect to surroundings of the vehicle in the driving situation by one or more surroundings sensors of the vehicle; and
select the HO state of the state machine for the driving situation of the vehicle based on sensor data of the one or more surroundings sensors.

5. The device according to claim 1, wherein
the plurality of different activated HO states includes N activated HO states, with N≥2, which are each associated with a different probability that the HO function will remain activated starting from a current time over a minimum period of time; and
the minimum period of time corresponds to a period of time required for deactivation of the HO function.

6. The device according to claim 5, wherein the device is configured, with decreasing probability of respectively selected HO states, to:
increase an amount or a degree of detail of information with respect to the surroundings of the vehicle or with respect to a driving strategy of the vehicle in the driving situation, which is output via a user interface of the vehicle; or
increase an extent of the monitoring of attentiveness which the driver of the vehicle has for the driving situation.

7. The device according to claim 1, wherein the plurality of different activated HO states includes a lane change HO state, which is directed to a lane change of the vehicle onto another lane, on which a probability that the HO function will remain activated starting from a current time over a minimum period of time is greater than on a lane on which the vehicle travels at the current time.

8. The device according to claim 1, wherein the device is configured:
based on sensor data from one or more surroundings sensors or based on a digital map for the roadway network traveled by the vehicle, to determine probability information with respect to a probability that the HO function will remain activated in the driving situation starting from a current time over a minimum period of time; and
to select the HO state of the state machine for the driving situation of the vehicle based on the probability information.

9. The device according to claim 1, wherein the device is configured:
based on sensor data from one or more surroundings sensors or based on a digital map for the roadway network traveled by the vehicle, to determine that the probability that the HO function will remain activated starting from a current time over a minimum period of time is greater on another lane than on a lane on which the vehicle is traveling at the current time; and
in reaction thereto, to pass into a lane change HO state of the state machine, which is directed to a lane change of the vehicle onto the another lane.

10. The device according to claim 1, wherein the device is configured, while the state machine is in an activated HO state, to effectuate automated lateral guidance of the vehicle and enable the driver of the vehicle to permanently take their hands off a steering wheel of the vehicle.

11. A method for operating a hands-off (HO) function of a vehicle, the method comprising:
operating a state machine for the HO function, wherein the state machine has a plurality of different activated HO states for the HO function and a deactivated HO state, in which the HO function is deactivated;
selecting the HO state of the state machine based on a driving situation of the vehicle; and
operating the HO function in the driving situation according to the HO state.
